(19) United States
(12) Patent Application Publication
(10) Pub. No.: US 2026/0326458 A1
(43) Pub. Date: Oct. 22, 2026

(54) SHEET DRYING APPARATUS AND INKJET RECORDING APPARATUS THEREWITH

(71) Applicant: KYOCERA Document Solutions Inc., Osaka (JP)

(72) Inventors: Masafumi SAITO, Osaka (JP); Hiroyuki UEDA, Osaka (JP); Mitsuhiro GODA, Osaka (JP); Masaki MURASHIMA, Osaka (JP); Minoru TOKONAMI, Osaka (JP); Yuto KOIKE, Osaka (JP)

(73) Assignee: KYOCERA Document Solutions Inc., Osaka (JP)

(21) Appl. No.: 19/639,881

(22) Filed: Apr. 6, 2026

(30) Foreign Application Priority Data
Apr. 16, 2025 (JP) 2025-067460
Aug. 21, 2025 (JP) 2025-138105

(51) Int. Cl. B41J 11/00; B41J 2/21

(52) U.S. Cl. CPC B41J 11/00216; B41J 2/2107; B41J 11/00212; B41J 11/0022

(57) ABSTRACT

A sheet drying apparatus includes a conveying portion and a drying portion. The conveying portion conveys a sheet having an image formed on it with ink containing moisture. The drying portion is disposed to face the conveying portion, and dries the ink attached to the sheet. The drying portion includes a first drying portion that has a heating device for heating the sheet with infrared radiation and that evaporates a predetermined amount of the moisture in the ink to increase the viscosity of the ink and a second drying portion that has an irradiating device for irradiating the sheet with energy radiation and that heats only the ink to evaporate the moisture in the ink. The irradiating device irradiates the sheet with first energy radiation having a wavelength peak at least at 450 nm to 600 nm by use of a light-emitting diode.

### INCORPORATION BY REFERENCE

This application is based on and claims the benefit of priority from Japanese Patent Application No. 2025-067460 filed on Apr. 16, 2025 and Japanese Patent Application No. 2025-138105 filed on Aug. 21, 2025, the contents of both of which are hereby incorporated by reference.

### BACKGROUND

The present disclosure relates to a sheet drying apparatus that dries a sheet having an image printed on it by an inkjet recording apparatus or the like, and also relates to an inkjet recording apparatus and an image forming system provided with such a sheet drying apparatus.

Inkjet recording apparatuses, which form an image by ejecting ink onto a sheet, are widely used as recording apparatuses such as facsimile machines, copiers, and printers. On the other hand, sheet drying apparatuses are known that heat and thereby dry a sheet (of a recording medium) having ink deposited on it by an inkjet recording apparatus.

When an image is recorded using water-based ink on a coated sheet, that is, a sheet with a coated surface, since the ink has difficulty permeating the sheet, the ink takes time to dry. Drying with an infrared heater causes a large thermal deformation in the sheet. Drying by irradiation with light from an LED heats the ink instantaneously and tends to leave a ring-shaped evaporation residue (coffee stain) as appears after evaporation of liquid containing particles.

### SUMMARY

According to one aspect of the present disclosure, a sheet drying apparatus includes a conveying portion and a drying portion. The conveying portion conveys a sheet having an image formed on it with ink containing moisture. The drying portion is disposed to face the conveying portion, and dries the ink attached to the sheet. The drying portion includes a first drying portion that has a heating device for heating the sheet with infrared radiation and that evaporates a predetermined amount of the moisture in the ink to increase the viscosity of the ink, and a second drying portion that has an irradiating device for irradiating the sheet with energy radiation and that heats only the ink to evaporate the moisture in the ink. The irradiating device irradiates the sheet with first energy radiation having a wavelength peak at least at 450 nm to 600 nm by use of a light-emitting diode.

### BRIEF DESCRIPTION OF THE DRAWINGS

FIG. 1 is a schematic diagram showing the internal construction of an image forming system including a sheet drying apparatus according to the present disclosure.

FIG. 2 is a side sectional view around a first drying portion and a second drying portion in the sheet drying apparatus according to one embodiment of the present disclosure.

FIG. 3 is a graph showing, for each of inks of different colors, the relationship between light wavelength and light absorbance observed when the ink is irradiated with light.

FIG. 4 is a graph showing the emission wavelength distribution observed with a blue LED, with a yellow LED, with the combination of the blue LED and the yellow LED, and with an ultraviolet (UV) LED.

### DETAILED DESCRIPTION

### [1. Configuration of an Image Forming System Including a Sheet Drying Apparatus]

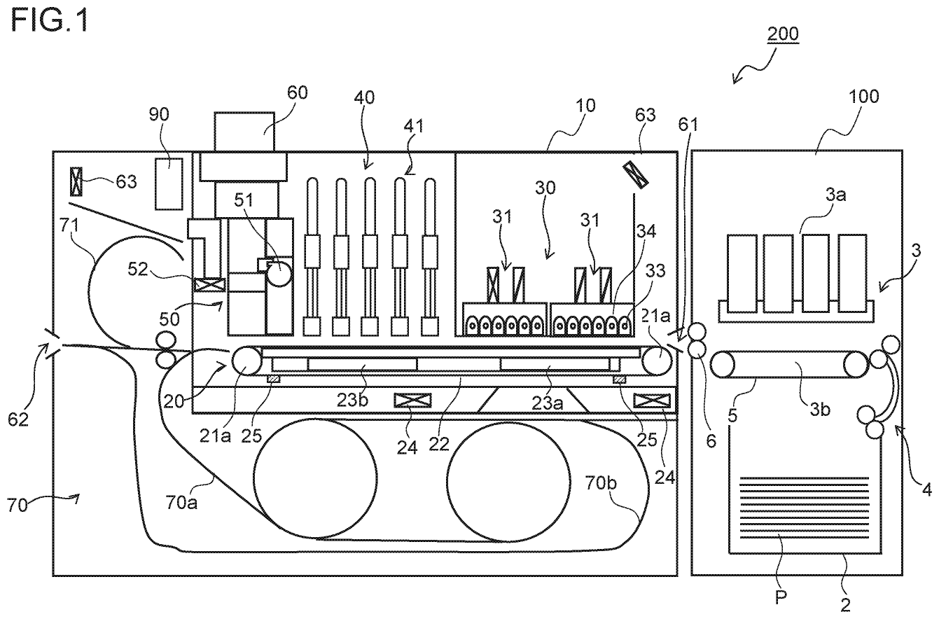

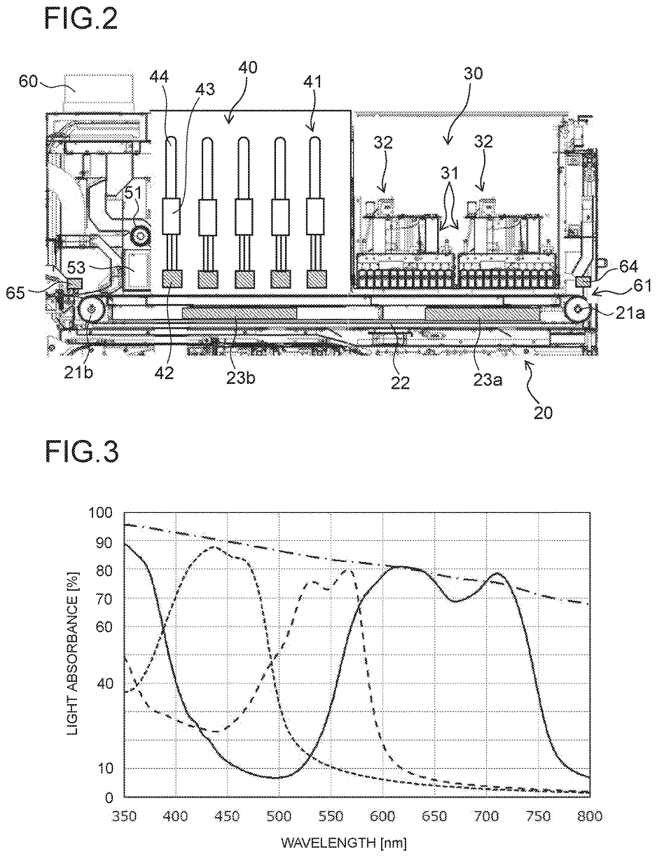

An embodiment of the present disclosure will be described below with reference to the accompanying drawings. FIG. 1 is a schematic diagram showing the internal construction of an image forming system 200 including a sheet drying apparatus 10 according to the present disclosure. FIG. 2 is a side sectional view around a first drying portion 30 and a second drying portion 40 in the sheet drying apparatus 10 according to one embodiment of the present disclosure. Now, with reference to FIGS. 1 and 2, the image forming system 200 that incorporates an image forming apparatus 100 and the sheet drying apparatus 10 will be described.

The image forming apparatus 100 is a printer of an inkjet recording type, and includes a sheet storage portion 2 disposed in a lower part of the image forming apparatus 100, an image forming portion 3 disposed above the sheet storage portion 2, and a sheet feed portion 4 for feeding a sheet P stored in the sheet storage portion 2 to the image forming portion 3.

The image forming portion 3 is composed of a recording portion 3a having a plurality of recording heads and a printing conveying portion 3b disposed opposite the recording portion 3a. The printing conveying portion 3b includes an endless printing conveying belt 5 wound around a plurality of rollers including a driving roller. The sheet P conveyed by the sheet feed portion 4, while being held on the printing conveying belt 5 under suction by a sheet sucking portion (not shown) disposed inward of the printing conveying belt 5, passes under the recording portion 3a. The sheet P having a predetermined image recorded to it by the image forming portion 3 is discharged through a pair of discharge rollers 6 to be carried into the sheet drying apparatus 10.

The sheet drying apparatus 10 is disposed adjacent to the image forming apparatus 100 and dries the ink on the sheet P discharged from the image forming apparatus 100. The sheet drying apparatus 10 includes a first conveying portion 20, a first drying portion 30, a second drying portion 40, a suction fan unit 50, a second conveying portion 70, and a control portion 90.

The first conveying portion 20 includes a driving roller 21a, a driven roller 21b, and a conveying belt 22. The conveying belt 22 is wound around the driving roller 21a and the driven roller 21b, which are disposed downstream and upstream, respectively, with respect to the conveying direction of the sheet P (from right to left in FIG. 1, in the following description referred to simply as the conveying direction).

Inward of the conveying belt 22, sheet sucking portions 23a and 23b are disposed. The conveying belt 22 has formed in it a number of suction holes (not shown) through which to pass suction air for sucking the sheet P onto the conveying belt 22 under negative pressure suction by the sheet sucking portions 23a and 23b.

Below the conveying belt 22, cooling fans 24 are disposed in two places. Moreover, close to the bottom face of the conveying belt 22, a belt temperature sensor 25 is disposed. When the temperature sensed by the belt temperature sensor 25 is equal to or higher than a predetermined temperature, the cooling fan 24 sends cooling air to the conveying belt 22.

The first drying portion 30 is disposed closely downstream of a sheet inlet port 61 with respect to the conveying direction, and evaporates the moisture contained in the ink on the sheet P carried in through the sheet inlet port 61 to increase the viscosity of the ink. The first drying portion 30 includes a heating unit 31 and a hot-air fan 32.

The heating unit 31 comprises two heating units disposed along the conveying direction (direction indicated by arrow X) so as to face the top face of the conveying belt 22. Each heating unit 31 includes heaters 33 extending in the sheet width direction (the direction orthogonal to the plane of FIGS. 1 and 2, in the following description referred to simply as the width direction), which is horizontally orthogonal to the conveying direction, and reflectors 34 in a U-shape as seen from the side that are disposed so as to enclose the heaters 33 from above. In the embodiment, infrared heaters are used as the heaters 33.

The hot-air fan 32 is disposed above the heating unit 31. More specifically, the hot-air fan 32 is disposed so as to send air toward the reflectors 34 from above. The air blown from the hot-air fan 32 onto the reflectors 34 is heated while passing through the gaps between the reflectors 34 to become hot air, which flows into the gap (drying space) between the heating unit 31 and the conveying belt 22.

If stream or water vapor is present in the gap between the heating unit 31 and the conveying belt 22, it absorbs the infrared radiation emitted from the heater 33 and reflected off the reflector 34; this impairs the performance of the drying of the ink on the sheet P. To cope with that, hot air is sent by the hot-air fan 32 into the gap between the heating unit 31 and the conveying belt 22 to dissipate and eliminate the stream or water vapor emanating from the sheet P; this ensures the drying of the ink with infrared radiation.

The second drying portion 40 is disposed adjacently downstream of the first drying portion 30 with respect to the conveying direction, and evaporates the moisture remaining in the ink on the sheet P having passed through the first drying portion 30 to dry the ink. The second drying portion 40 includes a light emitting unit 41.

The light emitting unit 41 comprises a plurality of (here, five) light emitting units disposed along the conveying direction (direction indicated by arrow X) so as to face the top face of the conveying belt 22. Each light emitting unit 41 includes an LED 42, a circuit board 43, and a water cooling pipe 44.

The LED 42 irradiates the ink on the sheet P passing through the second drying portion 40 with light (energy radiation) to evaporate the moisture remaining in the ink. The LED 42 emits light with a wavelength peak at least at 450 nm to 600 nm. In the present specification, assuming the use of a cut filter that transmits only light with needed wavelengths, “wavelength peak” denotes the wavelength peak of that part of the light emitted from the LED 42 that has been transmitted through the cut filter.

The circuit board 43 controls the driving of the LED 42 according to a control signal transmitted from the control portion 90. The water cooling pipe 44 is disposed adjacent to the LED 42 and the circuit board 43. Through the water cooling pipe 44 water is circulated to cool the LED 42 and the circuit board 43.

The suction fan unit 50 sucks the water vapor that emanates from the sheet P passing through the second drying portion 40. The suction fan unit 50 includes a suction fan 51 that sucks the air containing water vapor in the second drying portion 40 and a separation fan 52 that sends separating air for separating the sheet P from the conveying belt 22. The suction fan unit 50 communicates through a first duct 53 with the space between the conveying belt 22 and the light emitting unit 41, and communicates through a second duct 54 with an exhaust port 60 formed in an upper part of the sheet drying apparatus 10.

For taking in outside air into the sheet drying apparatus 10, a plurality of outside air intake fans 63 are disposed in suitable places in the sheet drying apparatus 10. In an upstream part and a downstream part of the first conveying portion 20 with respect to the conveying direction, sheet sensors 64 and 65 are disposed respectively. The sheet sensors 64 and 65 sense the sheet P passing through the sheet inlet port 61 and a sheet discharge port 62 respectively.

When the driving roller 21a is rotated, the conveying belt 22 turns counterclockwise; thus the sheet P carried in through the sheet inlet port 61 passes through the first drying portion 30 and the second drying portion 40 in this order to be either discharged via the sheet discharge port 62 out of the sheet drying apparatus 10 or conveyed into the second conveying portion 70.

The second conveying portion 70 is disposed below the first and second drying portions 30 and 40 across the first conveying portion 20. The second conveying portion 70 includes a reversing conveying passage 70a for reversing front to back the sheet P having the ink on it dried and a duplex conveying passage 70b for returning to the image forming apparatus 100 the sheet P reversed front to back to subject it to duplex printing.

Downstream (to the left in FIG. 1) of the suction fan unit 50 with respect to the conveying direction, a retraction path 71 in the shape of an arc is provided. The retraction path 71 is where a sheet P (waste sheet) no longer necessary due to printing failure or the like on the image forming apparatus 100 is retracted to be stocked.

The control portion 90 controls the first conveying portion 20, the first drying portion 30, the second drying portion 40, the suction fan unit 50, and the second conveying portion 70 according to control signals from a main control portion (not shown) in the image forming apparatus 100.

### [2. Emission Wavelength of the LED in the Second Drying Portion]

FIG. 3 is a graph showing, for each of inks of different colors, the relationship between light wavelength and light absorbance observed when the ink is irradiated with light. As shown in FIG. 3, cyan ink (indicated by a solid line in the graph) exhibits the maximum absorbance to light of wavelengths from 600 nm to 700 nm; magenta ink (indicated by a broken line in the graph) exhibits the maximum absorbance to light of wavelengths from 530 nm to 570 nm; yellow ink (indicated by a dotted line in the graph) exhibits the maximum absorbance to light of wavelengths from 430 nm to 470 nm; and black ink (indicated by a chain line in the graph) exhibits gradually decreasing absorbance with increasing light wavelengths from 350 nm to 800 nm.

The light energy E absorbed by ink is given by formula (1) below.

E=(Cumulative Light Absorbance)×(Emission Intensity)×(Number of Waves) (1)
where
(Cumulative Light Absorbance) is the cumulative value of light absorbance at wavelengths from 350 nm to 750 nm; and
(Number of Waves) is the reciprocal of the wavelength.

As will be clear from FIG. 3, even though the LED 42 emits light of a constant wavelength, the light absorbance of ink greatly varies with the color of the ink. Accordingly, for example, if as the LED 42 a blue LED that emits blue light of wavelengths from 450 nm to 500 nm is used, while yellow ink absorbs more light energy E, cyan and magenta inks absorb less light energy E. As a result, while yellow ink can be dried sufficiently, cyan and magenta inks are difficult to dry.

On the other hand, if as the LED 42 a yellow LED that emits yellow light of wavelengths from 500 nm to 600 nm is used, while cyan and magenta inks absorb more light energy E, yellow ink absorbs less light energy. As a result, while the cyan and magenta inks can be dried sufficiently, yellow ink is difficult to dry.

Out of the above considerations, in the embodiment, an LED 42 that can emit light with two peak wavelengths (double peaks) corresponding to blue and yellow light is used. Such an LED 42 can be set up by arranging a blue LED and a yellow LED in combination, or by making a blue LED emit light and transmitting this light through a cut filter configured with glass or transparent film coated with YAG (yttrium aluminum garnet) to produce light with two peak wavelengths corresponding to blue and yellow light.

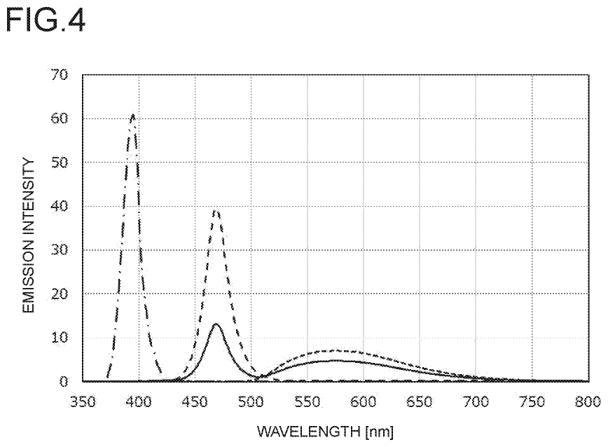

FIG. 4 shows the emission wavelength distribution observed with a blue LED (NCSB170FT, manufactured by Nichia Corporation), with a yellow LED (NCSY170FT, manufactured by Nichia Corporation), with the combination of the blue and yellow LEDs, and with an ultraviolet (UV) LED (manufactured by Kyocera Corporation). On the other hand, Table 1 lists the light energy absorbed by cyan, magenta, yellow, and black inks as observed with the blue LED, with the yellow LED, with the combination of the blue and yellow LEDs, and with the ultraviolet (UV) LED.

In FIG. 4, the emission wavelength distribution with the blue LED is indicated by a broken line, the emission wavelength distribution with the yellow LED is indicated by a dotted line, the emission wavelength distribution with the combination of the blue and yellow LEDs (double peaks) is indicated by a solid line, and the emission wavelength distribution with the ultraviolet (UV) LED is indicated by a chain line. The values listed in Table 1 are normalized relative to the color that exhibits the highest light energy among cyan, magenta, and yellow taken as 100.

TABLE 1

| | Cyan | Magenta | Yellow | Black | max/min |
|---|---|---|---|---|---|
| Blue LED | 14.2 | 45.6 | 100.0 | 119.3 | 8.4 |
| Yellow LED | 100.0 | 72.3 | 15.8 | 141.5 | 8.9 |
| Blue and Yellow LEDs | 96.0 | 100.0 | 99.4 | 220.6 | 2.3 |
| UV LED | 77.1 | 43.4 | 100.0 | 143.9 | 3.3 |

As will be clear from Table 1, with the configuration of the present disclosure, in which a blue LED and a yellow LED are arranged in combination and light with two peak wavelengths (double peaks) corresponding to blue and yellow light is emitted, it is possible to make even the light energies absorbed by cyan, magenta, and yellow inks. Moreover, the ratio (max/min) of the light energy absorbed between cyan ink, which absorbs least, and black ink, which absorbs most, is as low as 2.3. That is, it is possible to make even the light energies absorbed by all colors.

By contrast, with the yellow LED alone, yellow ink absorbs less light energy and, with the blue LED alone, cyan and magenta inks absorb less light energy, in either case leaving ink of one or more colors difficult to dry.

On the other hand, with the ultraviolet LED alone, magenta ink absorbs less light energy. Even if ink of a color difficult to dry can be dried with little deformation of the sheet, drying an image of a secondary color produced with inks of a plurality of colors overlaid on each other resulted in marked coarseness in the image.

With the configuration according to the embodiment, in the first drying portion 30, using the heating unit 31 provided with the infrared heater, while the ink is kept at low temperature to suppress evaporation of moisture in the sheet P, the moisture in the ink is evaporated to a certain degree to increase the viscosity of the ink. After that, in the second drying portion 40, using the light emitting unit 41 provided with the LED 42, only the ink is heated to evaporate the moisture remaining the ink to dry the ink. With this method of drying ink in two steps, even if the sheet P is a coated sheet, it is possible to efficiently dry ink on the sheet P while suppressing deformation of the sheet P.

More specifically, first, with the infrared heater in the first drying portion 30, a cumulative amount of light corresponding to about a half of the energy needed to dry ink is imparted, and then, by irradiation with light from the LED 42 in the second drying portion 40, the ink is dried completely. In this way, it is possible, while suppressing deformation of the sheet P, to effectively suppress the coarseness observed when a secondary color is produced with inks of a plurality of colors overlaid on each other.

The LED 42 having a plurality of emission wavelength peaks contributes to even light energy absorbances among inks of different colors. This helps reduce the difference in drying time among inks of different colors and thus helps avoid inconveniences such as insufficient drying and blistering resulting from different inks varying in ease of drying.

As shown in FIG. 3, cyan and yellow inks exhibit greatly different light absorbances in their wavelength distributions. Thus, in converting part of blue light into green-yellow light with a filter, it is necessary to strike a balance in drying efficiency between cyan and yellow inks. The balance in drying efficiency between cyan and yellow inks can be adjusted by controlling the light energy absorbed by magenta ink.

Specifically, the cumulative value at 350 nm to 750 nm of the light absorbance (indicated by a broken line in FIG. 3) observed with magenta ink diluted by a factor of 3000 is multiplied by the emission intensity of, and then by the number of waves, of blue light (first energy radiation) emitted from a blue LED and transmitted through a filter to determine a light energy (first absorbed energy). On the other hand, the above cumulative value at range of 350 nm to 750 nm is multiplied by the emission intensity of, and then by the number of waves, of green-yellow light (second energy radiation) converted with the filter to determine a light energy (second absorbed energy). Here, the former (first) absorbed energy is controlled to fall in the range of 75% to 150% of the latter (second) absorbed energy.

If the first absorbed energy is less than 75% of the second absorbed energy, the emission intensity and the number of waves of blue light are too low; this reduces the drying efficiency of yellow ink, which produces heat by absorbing blue light. If the first absorbed energy is more than 150% of the second absorbed energy, the emission intensity and the number of waves of blue light are too high; this reduces the drying efficiency of cyan ink, which produces heat by absorbing green-yellow light.

By controlling the first absorbed energy in the range of 75% to 150% of the second absorbed energy, it is possible to strike a balance in drying efficiency between cyan and yellow inks. It is thus possible to make even the drying efficiency of all of the cyan, magenta, and yellow inks, and thereby to suppress uneven drying.

The above embodiment is in no way meant to limit the scope of the present disclosure, which can thus be implemented with any modifications made without departure from its spirit. For example, while the above embodiment deals with a sheet drying apparatus 10 that dries a sheet P having an image recorded to it with inks of four colors of cyan, magenta, yellow, and black, a sheet drying apparatus according to the present disclosure can dry a sheet P having an image recorded to it with ink of one to three colors or with inks of five or more colors.

In those cases, when a sheet P having an image recorded to it without the use of one of cyan, magenta, and yellow inks is dried, it is not always necessary to use an LED 42 that has a plurality of peak wavelengths. For example, when yellow ink is not used, a blue LED having a wavelength peak at 450 nm to 600 nm can be used as the LED 42.

While in the above embodiment the second drying portion 40 is disposed downstream of the first drying portion 30 with respect to the conveying direction, the second drying portion 40 can instead be disposed upstream of the first drying portion 30. With the second drying portion 40 disposed upstream of the first drying portion 30, however, the moisture in ink is heated instantaneously by the blue light (first energy radiation) and the green-yellow light (second energy radiation) emitted from the light emitting unit 41. This tends to cause coffee stain. To avoid this, it is preferable that, as in the embodiment described above, the second drying portion 40 be disposed downstream of the first drying portion 30.

While the above embodiment deals with, as one example of an image forming system 200, a configuration in which a sheet drying apparatus 10 is coupled to an image forming apparatus 100 implemented as an inkjet printer, needless to say, the sheet drying apparatus 10 can be used on its own without being coupled to an image forming apparatus 100. Moreover, a sheet drying apparatus according to the present disclosure can be used also as a drying portion disposed downstream of a recording head (recording portion) in an image forming apparatus 100 implemented as an inkjet printer.

The present disclosure finds applications in sheet drying apparatuses that dry sheets having images printed on them by an inkjet recording apparatus or the like. Based on the present disclosure, it is possible to provide a sheet drying apparatus that can efficiently dry ink containing moisture and that can also suppress deformation of a sheet resulting from its being heated, and to provide an inkjet recording apparatus and an image forming system provided with such a sheet drying apparatus.

What is claimed is:

1. A sheet drying apparatus comprising:
a conveying portion that conveys a sheet having an image formed thereon with ink containing moisture; and
a drying portion disposed to face the conveying portion, the drying portion drying the ink attached to the sheet,
wherein
the drying portion includes:
a first drying portion having a heating device that heats the sheet with infrared radiation, the first drying portion evaporating a predetermined amount of the moisture in the ink to increase a viscosity of the ink; and
a second drying portion having an irradiating device that irradiates the sheet with energy radiation, the second drying portion heating only the ink to evaporate the moisture in the ink, and
the irradiating device irradiates the sheet with first energy radiation having a wavelength peak at least at 450 nm to 600 nm by use of a light-emitting diode.

2. The sheet drying apparatus according to claim 1, wherein
the irradiating device irradiates the sheet at least with the first energy radiation and with second energy radiation having a wavelength peak at 500 nm to 600 nm.

3. The sheet drying apparatus according to claim 2, wherein
the irradiating device includes:
a blue light-emitting diode that generates the first energy radiation; and
a yellow light-emitting diode that generates the second energy radiation.

4. The sheet drying apparatus according to claim 2, wherein
the irradiating device includes:
a blue light-emitting diode that generates the first energy radiation; and
a filter that converts into the second energy radiation part of the first energy radiation generated by the blue light-emitting diode.

5. The sheet drying apparatus according to claim 4, wherein
the ink contains inks of three colors comprising cyan, magenta, and yellow inks, and when
a wavelength distribution of light absorbance at 350 to 750 nm with the magenta ink diluted by a factor of 3000 is multiplied by an emission intensity of, and then by a number of waves of, the first energy radiation having passed through the filter, to determine a first absorbed energy and
the wavelength distribution is multiplied by an emission intensity of, and then by a number of waves of, the second energy radiation converted by the filter, to determine a second absorbed energy, then
the first absorbed energy falls in a range of 75% to 150% of the second absorbed energy.

6. The sheet drying apparatus according to claim 1, wherein
the second drying portion is disposed downstream of the first drying portion with respect to a conveying direction of the sheet.

7. An inkjet recording apparatus comprising:
a recording portion that records an image to a sheet with ink containing moisture; and
the sheet drying apparatus according to claim 1 that dries the sheet having the image recorded thereto by the recording portion.

8. An image forming system comprising:
an inkjet recording apparatus that records an image to a sheet with ink containing moisture; and
the sheet drying apparatus according to claim 1 that dries the sheet having the image recorded thereto by the inkjet recording apparatus.
